(19) United States
(12) Patent Application Publication
(10) Pub. No.: US 2016/0343096 A1
(43) Pub. Date: Nov. 24, 2016

(54) EVALUATION OF PAYMENT FENCING INFORMATION AND DETERMINATION OF REWARDS TO FACILITATE ANTI-FRAUD MEASURES

(71) Applicant: EMPIRE TECHNOLOGY DEVELOPMENT LLC, Wilmington, DE (US)

(72) Inventor: Ezekiel Kruglick, Poway, CA (US)

(73) Assignee: Empire Technology Development LLC, Wilmington, DE (US)

(21) Appl. No.: 14/761,253

(22) PCT Filed: Jan. 14, 2015
(86) PCT No.: PCT/US2015/011485

§ 371 Date: Jul. 15, 2015

(51) Int. Cl. G06Q 50/14; G06Q 30/02; G06Q 20/40; G06Q 10/02

(52) U.S. Cl. CPC G06Q 50/14; G06Q 10/02; G06Q 30/0234; G06Q 20/4016

(57) ABSTRACT

Technologies are generally described that relate to facilitating evaluation of payment fencing information and determination of rewards. An example method may include receiving, by a device comprising a processor, first electronic information indicative of a purchase for travel by a first entity; and determining second electronic information indicative of a rebate associated with the travel, wherein the determining is based on receipt of payment fencing information related to the travel. In some embodiments, the method includes determining the level of completeness, quality and/or precision of the payment fencing information. For example, the completeness, quality and/or precision can be determined based on a predictable travel range of the first entity or a corresponding travel uncertainty of the first entity.

### TECHNICAL FIELD

The subject disclosure relates generally to evaluation of payment fencing information and determination of one or more rewards to facilitate one or more anti-fraud measures.

### BACKGROUND

Unless otherwise indicated herein, the materials described in this section are not prior art to the claims in this application and are not admitted to be prior art by inclusion of this section.

One impediment to transactions is a lack of security inherent to credit card companies when confronted with transactions originating outside of a typical geographical area associated with a consumer to whom the credit card belongs. Further, in many cases, the consumer may then incur the inconvenience of having an attempted transaction declined.

Many credit card payment methods offer incentives, such as 1-3% cash back, on various types of credit card spending. The cash back incentive may be used to motivate consumers to use a credit card for payment. Sometimes, credit card programs rotate earnings categories to further incentivize consumer behavior or offer incentives for particular actions. Meanwhile, it has been estimated that roughly 20%, of consumers lack confidence that banks will protect the consumers from payment card fraud, yet nearly half of the consumers take actions that potentially expose them to fraud.

An approach that banks are increasingly using to combat fraud is to use customer knowledge to attempt to refine fraud estimation. Some systems allow the customers to limit payment use to a defined geographic area, e.g., an area around a home address, and request customer action to enable use outside the defined geographic area. However, fraud detection efforts are hampered in a number of ways, including a recent rise of thin and insert skimmers, which can make detection of adverse capture of payment information difficult while using unfamiliar payment equipment.

Unfortunately, a travel period is one of the higher risk times for a traveling consumer attempting to pay for goods or services by credit card. During travel, the consumer may be in an unfamiliar area surrounded by unknown people, may be staying in a hotel at which staff have access to the hotel room, and/or may be making an unusual number of expensive purchases with merchants. These factors, inter alia, may make theft of payment information more likely and also may make it harder to identify fraud.

### SUMMARY

In various, non-limiting embodiments, systems, devices, methods and/or computer-readable storage media that facilitate the evaluation of payment fencing information and determination of rewards to facilitate anti-fraud measures are described herein.

In some embodiments, a method may comprise receiving, by a device comprising a processor, first electronic information indicative of a purchase for travel by a first entity, and determining second electronic information indicative of a rebate associated with the travel, wherein the determining is based on receipt of the payment fencing information related to the travel.

In another embodiment, a computer readable storage device is provided. The computer readable storage device stores executable instructions that, in response to execution, cause a device comprising a processor to perform operations. The operations may comprise determining electronic information indicative of a reward associated with travel of a first entity, wherein a level of the reward is based on a completeness of information about geographical locations corresponding to the travel. The operations may also comprise associating the electronic information indicative of the reward with a second entity.

In yet another embodiment, an apparatus is provided. The apparatus may comprise a processor, and a memory that stores executable instructions that, when executed by the processor, facilitate performance of operations. The operations may comprise generating first electronic information indicative of a purchase for travel by an entity. The operations may also comprise determining second electronic information indicative of a rebate associated with an itinerary for the travel. The determining may be based on receipt of the payment fencing information for the itinerary for the travel, and the payment fencing information may comprise third electronic information indicative of a first set of geographical locations at which the entity will be located during the travel during first defined time periods.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, various non-limiting embodiments are further described with reference to the accompanying drawings in which:

FIG. 1 illustrates an example block diagram of a system that provides evaluation of payment fencing information and determination of rewards to facilitate anti-fraud measures, in accordance with one or more embodiments described herein;

FIG. 2 illustrates an example block diagram of a system that provides evaluation of payment fencing information and determination of rewards to facilitate anti-fraud measures, in accordance with one or more embodiments described herein;

FIG. 3 illustrates an example block diagram of a system that provides evaluation of payment fencing information and determination of rewards to facilitate anti-fraud measures, in accordance with one or more embodiments described herein;

FIG. 4 illustrates an example block diagram of a system that provides evaluation of payment fencing information and determination of rewards to facilitate anti-fraud measures, in accordance with one or more embodiments described herein;

FIG. 5 illustrates an example block diagram of a payment fencing and reward device of the system of FIGS. 1, 2, 3 and/or 4, which may provide the evaluation of payment fencing information and determination of rewards to facilitate anti-fraud measures, in accordance with one or more embodiments described herein;

FIG. 6 illustrates an example block diagram of the reward determination device of the payment fencing and reward device of the system of FIGS. 1, 2, 3 and/or 4, in accordance with one or more embodiments described herein;

FIG. 7 illustrates an example block diagram illustrating a flow of operations within a payment network employing the example system of FIGS. 1, 2, 3 and/or 4, which may provide evaluation of payment fencing information and determination of rewards to facilitate anti-fraud measures, in accordance with one or more embodiments described herein;

FIGS. 8-12 illustrate flowcharts of example methods associated with evaluation of payment fencing information and determination of rewards to facilitate anti-fraud measures, in accordance with one or more embodiments described herein; and

FIG. 13 illustrates an example block diagram of a computing device that is arranged for providing the evaluation of payment fencing information and determination of rewards to facilitate anti-fraud measures, in accordance with one or more embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, may be arranged, substituted, combined, separated, and designed in a wide variety of different configurations, all of which are explicitly contemplated herein.

By one estimate, authorization processing devices rejected 7.5% of one class of international credit card orders due to suspicion of fraud in 2012, and rejected 2.9% of certain domestic orders due to suspicion of fraud in 2012. Together, these numbers suggest countless losses in needless transaction rejections that inconvenience the customer.

In light of extensive fraud, as mentioned, one approach that banks have employed is to allow customers to limit payment use to a particular geographic area (e.g., a 50 mile radius around a home address) and requesting user action to enable use outside the particular geographic area. This approach may be driven by specific application programming interfaces that utilize coordination and/or communication between one or more computers or mobile devices. However, conventional approaches based on usage of pre-programmed information are inadequate. Further, the current approaches of requesting consumers to call the bank or payment processor in advance of each travel experience may be inconvenient and unrealistic given the amount of travel many business professionals have on average during the year.

The above-described approach by itself is thus inadequate, but may be improved if the payment processor has detailed information regarding a trip being taken by a consumer. However, there are no approaches that offer incentives to consumers to provide travel information that may be employed for determining whether to limit payment use to a particular geographic area. Accordingly, one or more embodiments described herein address how to incentivize customers skeptical of bank anti-fraud techniques to exert the effort to provide travel information to the payment processor.

One or more embodiments described herein employ various cooperating machines, i.e., specific machines/technology that may perform a number of functions including, but not limited to, extraction of travel itinerary information from travel purchase information, comparison and evaluation of partial trip payment fencing information and additional trip payment fencing information to determine whether the two sets of information are inconsistent and therefore the additional trip payment fencing information provided may be erroneous, assessment and evaluation of the precision or quality of the additional trip payment fencing information, an estimation regarding particular inconvenience of providing the additional trip payment fencing information and the like. Numerous different specific machines may be employed and coordinated efforts between specialized machines may be employed to provide the one or more embodiments of determining the reward for the provider of the additional trip payment fencing information.

In some embodiments, a system that progressively rewards users for providing more detailed travel plans after a travel purchase, such as providing a reward based on the completeness of a payment fencing record, is provided. One or more of the embodiments described herein may incentivize entities (either consumers scheduled to travel or third-party travel partners through whom travel is arranged) to provide data describing travel-related consumer plans. One or more of the embodiments may reduce credit card fraud coupled with providing fewer denied valid transactions.

In various embodiments described herein, numerous operations may be performed by computers as opposed to being performed as abstract, disembodied or mental steps. These operations may comprise, but are not limited to, transmitting and/or receiving information over a wired or wireless channel, modulation and/or demodulation of signals received and/or transmitted, filtering of electronic travel purchase information and extraction of electronic information indicative of travel details, Hausdorff geometric criteria determination and the like. For instance, humans are incapable of practicing all of the operations of the various claimed embodiments, and therefore, ipso facto, the various embodiments cannot be mere implementations of well-known or fundamental economic or human behavior. The various embodiments do not simply recite a fundamental economic practice, a method of organizing human activities, an idea of itself, or a mathematical relationship/formula. Further, the separate concepts of (1) identifying a geofence and (2) employing payment fencing information for fraud detection are not long-standing practices and have arisen only with modern technology systems allowing computerized devices to implement coordinated communications approaches for identifying and/or tracking locations of devices, determining electronic information identifying locations from which transactions are originated around the world and the like. To be clear, geofencing is distinct from payment fencing. In particular, geofencing is associated with geographical location detection systems available in devices that facilitate generation of a signal from the device when the device enters or leaves a bounded area, for example, while payment fencing may be one or more fraud detection, risk management, transaction declination/approval operations that utilize the geofence or the geofencing information. For example, a geofence may be a term for a virtual perimeter for a real-world geographic area (e.g., a virtual radius around a store or a set of boundaries such as neighborhood boundaries or school attendance zones). As such, solutions described herein are not geofencing solutions; rather, solutions described herein are those that may, in some (not all) embodiments, use geofencing information or signals generated based on geofencing operations to perform other operations.

As used herein, the terms “payment fence information” and “payment fencing information” may be synonymous. As used herein, the term “payment fencing” may include, but is not limited to, estimating, determining, identifying and/or managing fraud risk based on geographic information (e.g., geofencing or geofencing information) and/or travel-related information (including, but not limited to, hotel, air, cruise ship, bus, train, travel tour, travel dates, landmarks or other travel itinerary information) for an entity; determining or performing operations, estimations or functions associated with determining or facilitating determination of whether to approve or decline an attempted transaction for an entity based on geographic information (e.g., geofencing or geofencing information) and/or travel-related information (including, but not limited to, hotel, air, cruise ship, bus, train, travel tour, travel dates, landmarks or other travel itinerary information).

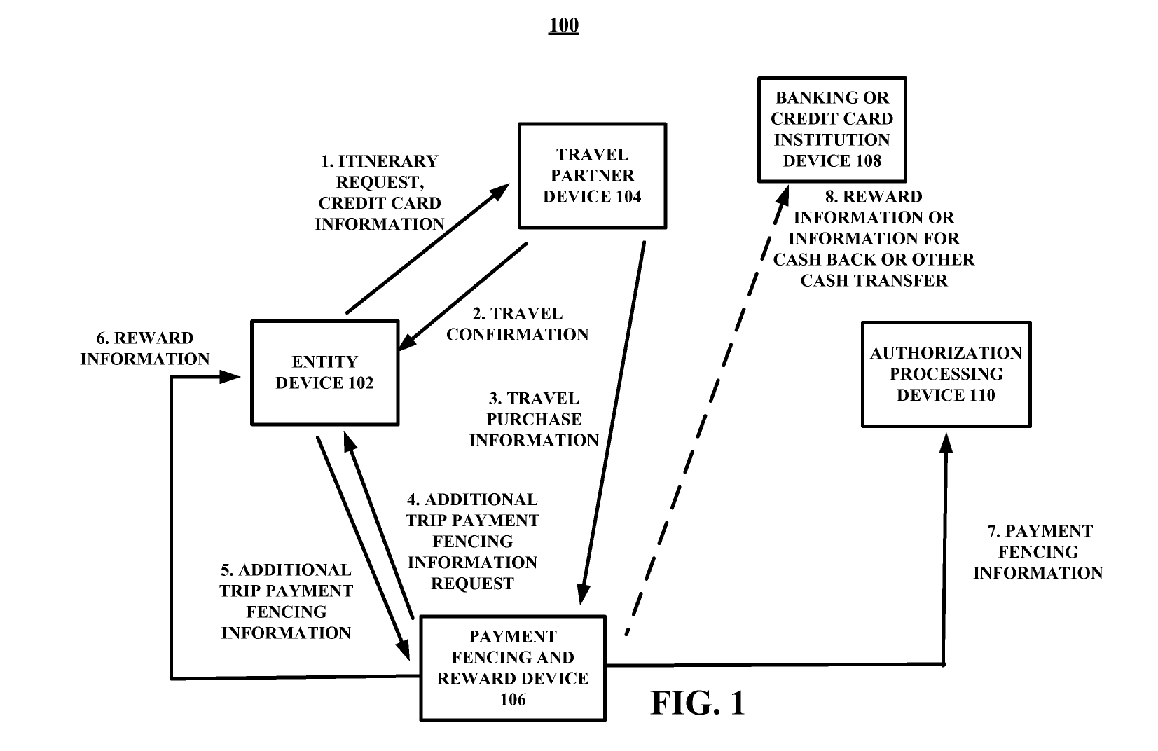

Turning now to the drawings, FIG. 1 illustrates an example block diagram of a system 100 that provides evaluation of the payment fencing information and determination of rewards to facilitate anti-fraud measures, in accordance with one or more embodiments described herein. The system 100 may be or may comprise a reward system that may progressively reward various different entities for providing more detailed travel plans associated with a travel purchase. As shown in FIG. 1, the system 100 comprises an entity device 102, a travel partner device 104 and a payment fencing and reward device 106. In various embodiments, one or more of the entity device 102, the travel partner device 104 and/or the payment fencing and reward device 106 may be electrically and/or communicatively coupled to one another to perform one or more functions of the system 100. In some embodiments, as shown, the system 100 may also comprise an authorization processing device 110 and/or a banking or credit card institution device 108 that may be communicatively coupled to and/or accessible by the payment fencing and reward device 106.

In the embodiment shown, the entity device 102 transmits at least some information indicative of an itinerary request for travel (e.g., air travel dates and city pairs) to the travel partner device 104. For example, the entity device 102 may transmit electronic information indicative of a selection of roundtrip air travel dates and an arrival and a departure city. In some embodiments, the entity device 102 may also transmit payment information to the travel partner device 104. The payment information may be or comprise credit card information, debit card information, bank account information or any other information that may be employed to purchase the itinerary request for travel.

The entity device 102 may be any number of different devices configured to transmit and/or receive electronic information over a wired or wireless channel. By way of example, but not limitation, in various embodiments, the entity device 102 may be or comprise a laptop, a cellular telephone, a personal computer, a tablet or any number of different devices configured to transmit and/or receive electronic information.

The travel partner device 104 may be any device configured to receive and/or process electronic information indicative of an itinerary request received from the entity device 102. In some embodiments, the travel partner device 104 may be any device configured to receive and/or process electronic information indicative of a requested travel itinerary that may be manually input at the travel partner device 104 by an entity. For example, the travel partner device 104 may be a device associated with a travel partner or other third-party entity (e.g., human entity or non-human entity) that sells, provides or otherwise facilitates procurement of travel either directly with the entity that will travel or as an intermediary. By way of example, but not limitation, the third-party entity may be ORBITZ® travel services, TRAVELOCITY® travel services, PRICELINE® travel services, VACATIONS TO ANYWHERE travel agency, ROYAL CARRIBEAN® cruise lines, AMERICAN AIRLINES®, AMTRAK® rail services, GREYHOUND® bus services, or the like.

Upon confirmation of the requested travel itinerary choice, the travel partner device 104 may transmit information indicative of a travel confirmation to the entity device 102. In some embodiments, the travel partner device 104, or a payment processing device (not shown) associated with processing payment from the payment information transmitted from the entity device 102, may transmit travel purchase information to the payment fencing and reward device 106. In some embodiments, the travel partner device 104, or the payment processing device, may store the travel purchase information in a data store, such as a database (not shown) stored at or accessible by the payment fencing and reward device 106.

In some embodiments, the travel purchase information may comprise, but is not limited to, dates and locations of travel (e.g., air travel dates and arrival/departure cities, hotel name, dates of stay and city, etc.). The travel purchase information may also comprise payment information from which the payment fencing and reward device 106 may determine whether the credit card or other payment method employed for purchase is associated with an account for which the payment fencing and reward device 106 is charged with monitoring.

In some embodiments, the payment fencing and reward device 106 receives the travel purchase information in response to transmitting a request for the travel purchase information. The request may be transmitted in any number of ways and/or take any number of forms comprising, but not limited to, via electronic mail, via an instruction to complete information at a designated website address, via application programming interface (API), via JavaScript Object Notation (JSON) message, via payment network message, via electronic information providing direction to a website address, or the like. In other embodiments, the entity device 102, the travel partner device 104 and/or the payment processing device transmits the travel purchase information to the payment fencing and reward device 106 prior to or without receipt of a request for the travel purchase information.

In any embodiment, based upon access of travel purchase information by the payment fencing and reward device 106 from a database or based on receipt of travel purchase information, the payment fencing and reward device 106 may filter and process the travel purchase information and extract pertinent travel information. In some embodiments, the pertinent travel information may include, but is not limited to, transportation or lodging itinerary information (e.g., air travel cities and dates of travel, train or bus departure or arrival cities and dates of travel, hotel cities and dates of lodging). The payment fencing and reward device 106 may store relevant travel information in a repository as partial trip payment fencing information. The partial trip payment fencing information may be stored at a defined payment fencing record, for example.

By way of example, but not limitation, based on purchase of one or more airline tickets, for example, the entity device 102, and/or the travel partner device 104, may receive an additional trip payment fencing information request from the payment fencing and reward device 106. The additional trip payment fencing information request may be an email or website prompt directing the entity device 102 and/or the travel partner device 104 to the defined payment fencing record. For example, the payment fencing and reward device 106 may prompt the entity device 102 and/or the travel partner device 104 to transmit information to further fill in the defined payment fencing record or, in some embodiments, to further fill in another payment fencing record that may be linked to or otherwise associated with the defined payment fencing record into which the partial trip payment fencing information was stored.

The defined payment fencing record may be already at least partially filled with the pertinent travel information extracted by the payment fencing and reward device 106 upon the entity device 102 and/or the travel partner device 104 accessing the defined payment fencing payment fencing record. In the current example, the defined payment fencing record may be already filled with information indicative of the one or more arrival cities that is part of the air travel itinerary.

In some embodiments, the travel partner device 104 may provide payment fencing information that fills in part of a defined payment fencing record. The entity device 102 may receive an additional trip payment fencing information request from the payment fencing and reward device 106. The additional trip payment fencing information request may be an email or website prompt/re-direct directing the entity device 102 to the defined payment fencing record (or to a payment fencing record associated with the defined payment fencing record that has been filled in based on payment fencing information from the travel partner device 104). As such, in some embodiments, the entirety of payment fencing information may be provided by a combination of the travel partner device 104 and the entity device 102.

In some embodiments, the email, website prompt or other communication from the payment fencing and reward device 106 directing the entity device 102 and/or the travel partner device 104 to the defined payment fencing record may also communicate information indicative of an incentive that will be provided to the entity device 102 and/or the travel partner device 104 if the entity device 102 and/or the travel partner device 104 provides the additional trip payment fencing information. In some embodiments, the payment fencing and reward device 106 may merely request the additional trip payment fencing information without providing information about a possible reward but reward the entity device 102 and/or the travel partner device 104 nonetheless upon receipt of the additional trip payment fencing information.

In the embodiment shown in FIG. 1, the payment fencing and reward device 106 may transmit the additional trip payment fencing information request to the entity device 102 and the entity device 102 may transmit the additional trip payment fencing information in response to the request. The entity device 102 may be incentivized to transmit the additional trip payment fencing information based on the opportunity to receive one or more rewards (e.g., cash back on the travel purchase, coupon, cash deposit into a defined account).

The payment fencing and reward device 106 may determine how much (an amount) or what type of a reward to provide to the entity device 102 based on any number of considerations. By way of example, but not limitation, the payment fencing and reward device 106 may determine the level of completeness, quality and/or precision of the additional trip payment fencing information provided by the entity device 102. The payment fencing and reward device 106 may then allocate a reward to the entity device 102 based on a progressively increasing sliding scale dictated by the level of completeness, the quality and/or the precision of the additional trip payment fencing information provided by the entity device 102. The more complete, high-quality and/or precise the additional trip payment fencing information, the more valuable the reward, for example. As another example, one type of reward may be provided for a certain type of information leading to the level of completeness, the quality and/or the precision while another type of reward may be provided for another type of information.

For example, the payment fencing and reward device 106 may have available a 3% rebate. The payment fencing and reward device 106 may determine the portion of the entire travel time for the entity that the payment fencing and reward device 106 may generate valid payment fencing information based on the additional trip payment fencing information provided. The higher the portion of time, the greater the fraction of the 3% rebate that the payment fencing and reward device 106 may allocate to the entity device 102. By way of example, but not limitation, the approximate percentage of travel time for which valid payment fencing may be determined may be or correspond to the percentage of the total reward (e.g., 3%) that may be provided by the payment fencing and reward device 106 to the entity device 102.

In one example, location data (e.g., hotel names and associated dates of stay, airport codes) may be compared with geolocation databases to determine whether the indicated hotels and/or airport codes may be converted to longitude and latitude. The multiple sets of coordinates may be organized into information that may be further processed by the payment fencing and reward device 106. For example, the multiple sets of coordinates may be organized into a series of circles that cover the area within a particular Hausdorff distance of all (or one or more of) the locations. The organization into the series of circles may be provided as a function of time since the entity associated with the entity device 102 is traveling. Thus, the output may be a series of input geometries (e.g., geofence input geometries) in a time series. The payment fencing and reward device 106 may be configured to forego providing a reward for instances in which the described process generates an error or uncertain output.

In some embodiments, the payment fencing and reward device 106 may also evaluate fraud detection strength for each time period (or for one or more time periods) associated with the period of travel of the entity. For example, if the information received by the payment fencing and reward device 106 regarding travel of an entity is limited to only specification of a country of travel, the payment fencing and reward device 106 may measure the fraud detection strength gained by receipt of the information specifying the country of travel by determining incremental statistical gains in fraud detection. The incremental gains may be determined to be minimal since only a country is provided. In contrast, if the payment fencing and reward device 106 receives information indicative of locations of specific hotels for each day of entity travel and information indicative of particular tours with specific monuments visited during the tour, the payment fencing and reward device 106 may determine that the fraud detection facilitated by such information may be much stronger than that facilitated by receipt of only information specifying countries of travel. The payment fencing and reward device 106 may employ a threshold system in which a particular amount of fraud detection statistical improvement is needed before the payment fencing and reward device 106 provides a reward. The approach may be employed to provide rewards that cost less than fraud detection gains. In some embodiments, the reward may be immediate or may take the form of enhanced cash back when the entity is traveling within the declared area specified via the itinerary identified in the payment fencing information.

In various embodiments, the payment fencing and reward device 106 may determine whether the payment fencing and reward device 106 may generate a valid geofence or other location based screening criteria based on the additional trip payment fencing information or based on a combination of the additional trip payment fencing information and the partial trip payment fencing information.

A geographic location may be interpreted via geocoding. Geocoding is the process of converting addresses (like “1600 Amphitheatre Parkway, Mountain View, Calif.”) into geographic coordinates (e.g., latitude 37.423021 and longitude −122.083739) which may be used in payment fencing. Geocoding may be performed algorithmically and using databases, often by dedicated applications that provide computational access externally. For example a system such as the ones discussed here may transmit a human-readable input of a location to the Google Geocoding API using a message to a URL of the form https://maps.googleapis.com/maps/api/geocode/json?parameters, where the parameters contain the input location. The returned values are translated into the necessary machine-usable format to implement payment fencing as described herein. An example of a python code fragment (from a larger application) for processing location names in colloquial language into JavaScript Object Notation code location and then latitude and longitude for performing such operations is as follows:

```
geo = geocoders.GoogleV3( )
location_cache = dict( )
for key in payment_fencing.data.keys( ):
  # Clean up descriptive word additions that don't contribute to location coding
  payment_fencing.data[key][‘location’] =
payment_fencing.data[key][‘location’].replace(‘Greater’,‘’).replace(‘Area’,‘’).replace(‘National’,‘’)
  payment_fencing.data[key][‘location’] =
payment_fencing.data[key][‘location’].replace(‘Capital’,‘’).replace(‘Region’,‘’)
  if ‘latitude’ not in payment_fencing.data[key]:
    payment_fencing.data[key][‘latitude’] = None
  if ‘longitude’ not in payment_fencing.data[key]:
    payment_fencing.data[key][‘longitude’] = None
  if payment_fencing.data[key][‘location’] not in location_cache.keys( ): #
caching to reduce geocoding calls
  if payment_fencing.data[key][‘latitude’] and
payment_fencing.data[key][‘longitude’] and (payment_fencing.data[key][‘longitude’]!=
360): # Cache if the record already has lat lng
      location_cache[payment_fencing.data[key][‘location’]] =
(payment_fencing.data[key][‘latitude’],payment_fencing.data[key][‘longitude’])
    else:
      try:
        place,(lat,lng) =
geo.geocode(payment_fencing.data[key][‘location’],exactly_one=False)[0] #
exactly_one and the [0] are to deal with multiple returns by taking the top one, see
https://code.google.com/p/geopy/wiki/GettingStarted
        print(‘ Geocoder called on: ’,payment_fencing.data[key][‘location’])
        location_cache[payment_fencing.data[key][‘location’]]=(lat,lng) #
Add the new result to the cache
      except:
        print(‘Geocoder failed on: ’,payment_fencing.data[key][‘location’])
```

| | |
|---|---|
| lat, lng = 0,0 | # Means invalid data, |

```
watch for it in mapping
  else:
    (lat,lng) = location_cache[payment_fencing.data[key][‘location’]] # Use
the cache if it was in there already
payment_fencing.data[key][‘latitude’] = lat
if lng<=0:
  lng = 360+lng
payment_fencing.data[key][‘longitude’] = lng
```

The payment fencing and reward device 106 may determine a level of quality of the additional trip payment fencing information based on comparing the additional trip payment fencing information with the partial trip payment fencing information and detecting discrepancies or errors. For example, assuming the partial trip payment fencing information is accurate since it was extracted from the travel purchase information, the payment fencing and reward device 106 may determine whether the additional trip payment fencing information provided by the entity device 102 indicates travel dates other than those in the travel date period specified by the travel purchase information. In some embodiments, the payment fencing and reward device 106 may reduce the reward based on the number or percentage of errors as described herein.

The payment fencing and reward device 106 may determine a level of precision of the additional trip payment fencing information based on identifying a granularity of detail of the information provided. For example, additional trip payment fencing information providing information about locations along a cruise ship excursion tour and times for the different locations may be considered by the payment fencing and reward device 106 as more precise than additional trip payment fencing information that provides mere disembarkation locations for the same cruise ship excursion tour.

In some embodiments, the payment fencing and reward device 106 may also determine the amount of reward to provide based on perceived effort needed or expended to provide the additional trip payment fencing information as opposed to final specificity of the additional trip payment fencing information. For example, the payment fencing and reward device 106 may give full credit for days of travel for which the payment fencing and reward device 106 received some amount of information even if the information may not be useful for payment fencing. In some cases, the payment fencing and reward device 106 may give full credit to the additional trip payment fencing information that indicates larger areas within which travel may occur if the entity is uncertain of specific travel plans upon arrival, and the additional trip payment fencing information is deemed sufficient for payment processing/fraud detection even if the additional trip payment fencing information is not determined to be specific geographically (e.g., “at sea” may be given full credit as the additional trip payment fencing information provided for travel via cruise ship).

While the payment fencing and reward device 106 may provide a reward to an entity, in various embodiments, the payment fencing and reward device 106 may provide or transmit a communication, to the entity device 102, indicative of reward information describing a reward. In some embodiments, the payment fencing and reward device 106 may provide or transmit the communication to the banking or credit card institution device 108 that may be able to receive information for crediting an account (e.g., bank account, credit card account, etc.), receive an electronic transfer of funds provided as a reward, or the like.

In some embodiments, the payment fencing and reward device 106 may access, gather and/or process detailed travel information so that the payment fencing and reward device 106 may generate the payment fencing information that may be employed to reduce the occurrence of fraud while accommodating an entity's travels. As shown in FIG. 1, the payment fencing and reward device 106 may transmit the payment fencing information associated with travel for the entity to the authorization processing device 110.

The payment fencing information may be any information specifying an area (of any shape) or geographic location (specified by longitude or latitude or specified in any number of different ways identifying a location). There may be one or more areas or geographic locations associated with one or more different locations of travel during the trip. By way of example, but not limitation, upon arrival at city A at time y, the payment fencing information may indicate a geographic location of city A at time y and for an hour after time y. A second set of the payment fencing information may be located in proximity of the hotel at which entity will be residing and may be associated with a time z, which is associated with a time period starting from approximately one half hour after arrival at the airport at time y. The foregoing is a mere example and any number of sets of the payment fencing information may be specified during the trip. The payment fencing information may comprise any one or more of geographic locations, areas, times, time periods, or dates, or any combination of the one or more of the geographic locations, the areas, the times, the time periods, or the dates.

In various embodiments, the authorization processing device 110 may compare the payment fencing information for an entity on a particular day and/or time of the travel to a location from which an attempted transaction originates during the period of travel. If the attempted transaction during travel is outside of the geofence associated with that particular day and/or time of the travel, the authorization processing device 110 may decline the attempted transaction. As used herein, the authorization processing device 110 may be any type of device associated with a payment processing entity that approves or declines attempted transactions (e.g., attempted credit card, debit card, bank account, wire transfer or other transaction).

As such, one or more embodiments of the system 100 may offer a reward or rebate (e.g., cash back, coupon, cash, or the like) that is provided to an entity based on receipt of information indicating payment fencing guidelines for a trip (e.g., by indicating which cities or parts of a foreign country the entity may be located in each day of the trip). This information may be useful because card and payment theft may occur during travel and because it is harder to perform intelligent fraud prevention while an entity is traveling if the travel times and routes are not known. However, if the payment fencing and reward device 106 has received or accessed information indicating travel to a different city for each day of a trip, for example, a third-party stealing payment credentials at hotel checkout in the first city may not be able to use the payment credentials for fraud at any time after the entity has left the city as specified in the additional trip payment fencing information or as identified by the payment fencing and reward device 106 as the partial trip payment fencing information. The payment fencing information generated by the payment fencing and reward device 106, if enough information has been obtained to generate detailed payment fencing information, may allow the authorization processing device 110 to detect or isolate authorized spending around the known path of the entity. Spending outside of the known path may then be subject to a higher level of suspicion (for example, requesting phone validation or the requested use of any other positive confirmation strategy).

In some embodiments, the payment fencing fraud detection may apply higher suspicion against any attempted transaction outside the area of the entity travel, with scaling and severity proportional to certainty of location. Relatively speaking, a more complete set of the payment fencing information may allow the authorization processing device 110 to perform more complex analysis. For example, the authorization processing device 110 may have the payment fencing information that indicates a particular entity is scheduled to take a train from one country to another on a Wednesday during the trip, and may observe the particular entity attempting to make purchases at the destination country after the time on the train on that Wednesday. The authorization processing device 110 may then determine that the particular entity rode the train and has completed that leg of the travel. After determining that this leg of travel has been completed, the authorization processing device 110 may be more skeptical of charges in the origin city at which the entity boarded the train. Such payment fencing approaches allow for less aggressive fraud prevention measures in the places where the entity is expected to be located, and thus may reduce the likelihood of the application of overaggressive fraud prevention resulting in an unwanted shutdown of entity credit during travel by the consumer.

As such, one or more embodiments of the system 100 may enable the authorization processing device 110 to obtain the payment fencing information for performing improved payment fencing-based fraud detection. One or more of the embodiments described herein may incentivize and encourage entities to provide more complete data about travel resulting in reduced fraud coupled with fewer denied valid transactions.

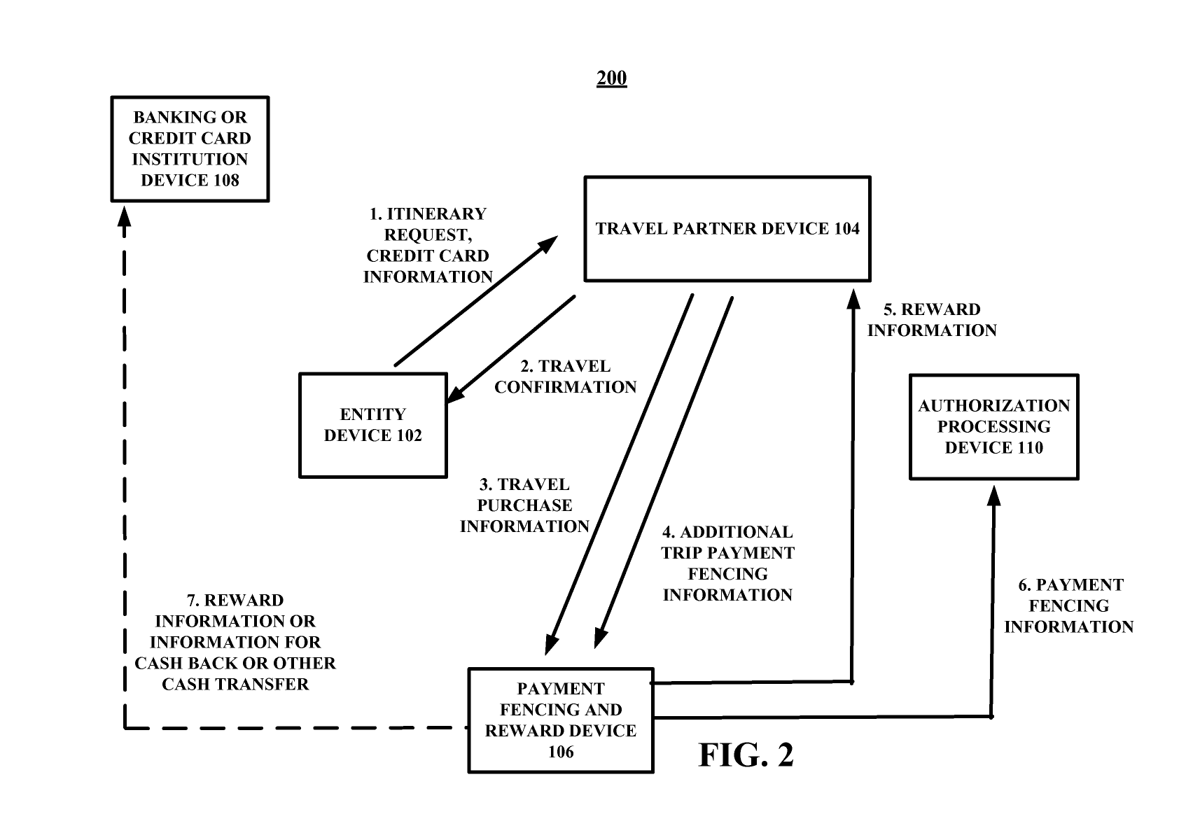

FIG. 2 illustrates an example block diagram of a system 200 that provides evaluation of the payment fencing information and determination of a reward or rewards to facilitate an anti-fraud measure or measures, in accordance with one or more embodiments described herein. Repetitive description of like elements employed in respective embodiments of systems and/or apparatus described herein are omitted for sake of brevity.

One or more of the components (e.g., structure and/or functionality) of the system 200 may be similar to that of the system 100; however, as shown, in the system 200, the payment fencing and reward device 106 receives, from the travel partner device 104, at least some of the additional trip payment fencing information regarding a travel itinerary for an entity associated with the entity device 102. Similar to the description of FIG. 1, the payment fencing and reward device 106 determines an amount or type of reward for the travel partner device (instead of determining an amount or type of reward for the entity that will travel) based on receipt of the additional trip payment fencing information from the travel partner device 104. As described with reference to FIG. 1, the payment fencing and reward device 106 may provide the specific amount of reward based on any number of factors comprising, but not limited to, the level of completeness, the quality and/or the precision of the additional trip payment fencing information (and/or for the level of completeness, the quality and/or the precision of the additional trip payment fencing information in combination with the partial trip payment fencing information accessed and/or received by the payment fencing and reward device 106). As also shown, in some embodiments, reward information or information for cash back or other cash transfer may be transmitted from the payment fencing and reward device 106 to the banking or credit card institution device 108 for a reward or credit or cash for a travel partner for providing the information for the entity.

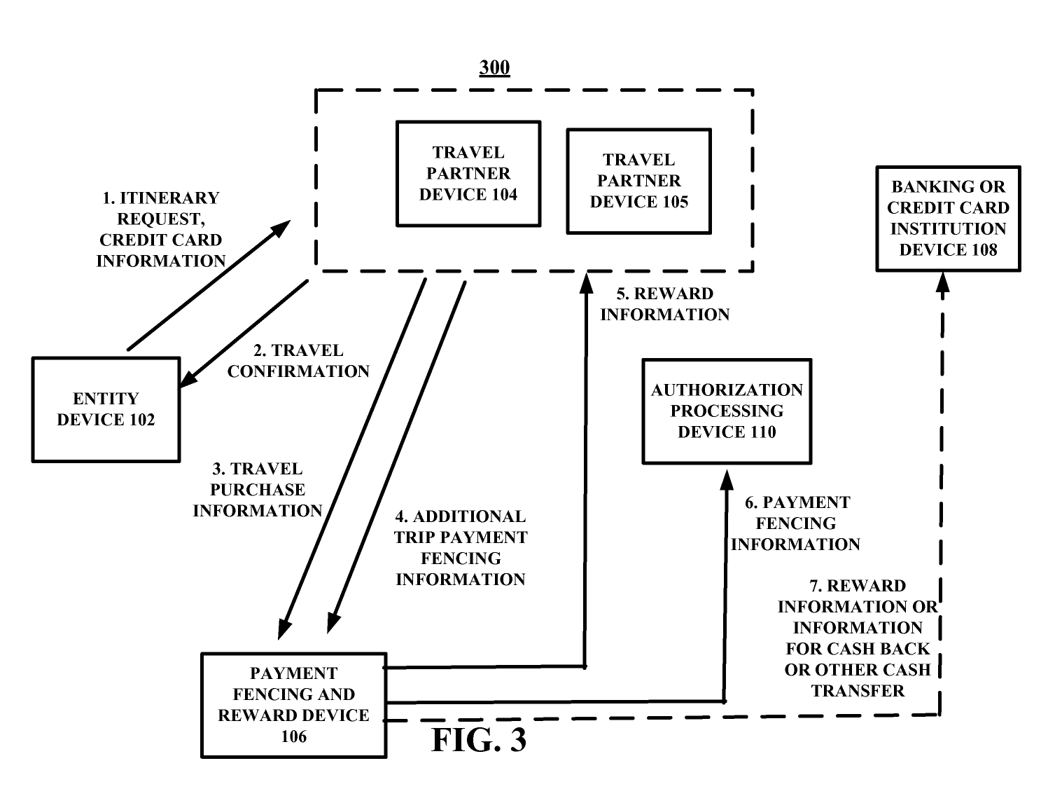

FIG. 3 illustrates an example block diagram of a system 300 that provides evaluation of the payment fencing information and determination of a reward or rewards to facilitate an anti-fraud measure or measures, in accordance with one or more embodiments described herein. Repetitive description of like elements employed in respective embodiments of systems and/or apparatus described herein are omitted for sake of brevity.

One or more of the components (e.g., structure and/or functionality) of the system 300 may be similar to that of the system 200; however, as shown, in the system 300, numerous travel partner devices (e.g., the travel partner device 104, and travel partner device 105) may provide the additional trip payment fencing information to the payment fencing and reward device 106 for a particular entity. For example, numerous travel partners may have information about travel for the particular entity for the same trip since, for example, the entity device 102 associated with the entity may transmit information for purchase of air fare from one travel partner (e.g., the travel partner device 104) and transmit information for purchase of hotel accommodations in specific cities from another travel partner (e.g., the travel partner device 105). The payment fencing and reward device 106 may allocate and transmit reward information to one or more of the travel partner devices 104, 105 and/or to bank or credit institution devices (e.g., the banking or credit card institution device 108) for one or more of the travel partner devices 104, 105 from whom the additional trip payment fencing information is received by the payment fencing and reward device 106.

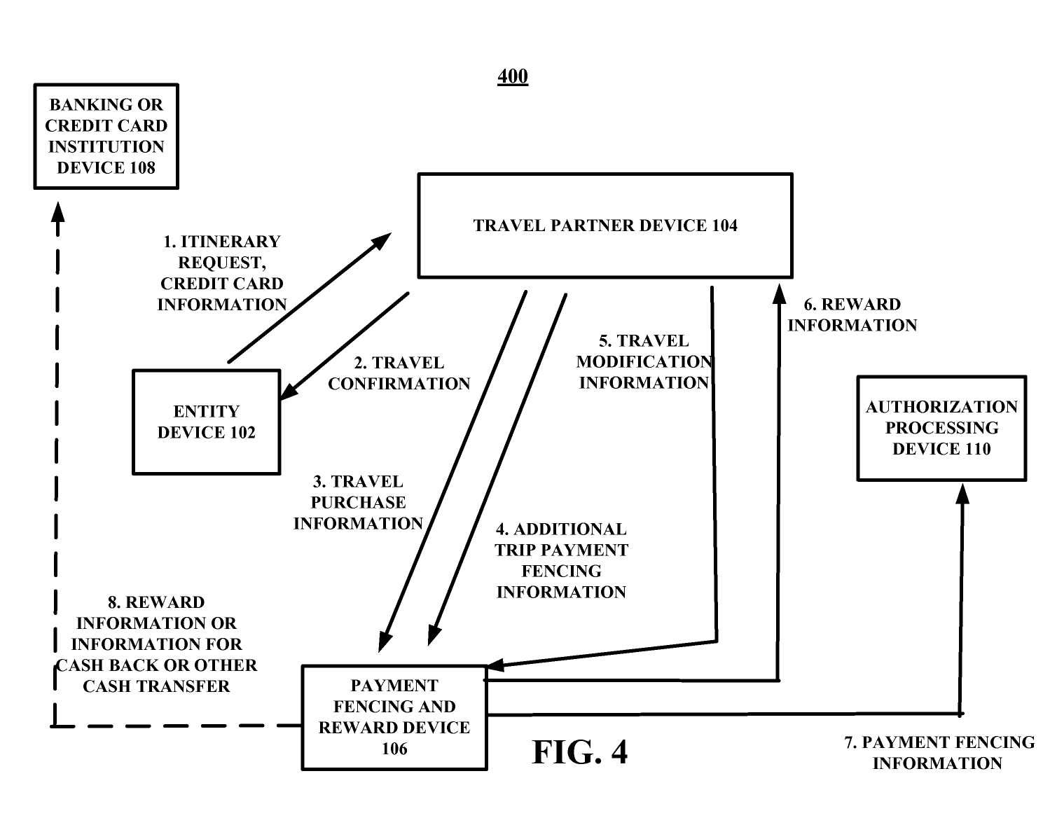

FIG. 4 illustrates an example block diagram of a system 400 that provides evaluation of the payment fencing information and determination of a reward or rewards to facilitate an anti-fraud measure or measures, in accordance with one or more embodiments described herein. Repetitive description of like elements employed in respective embodiments of systems and/or apparatus described herein are omitted for sake of brevity.

One or more of the components (e.g., structure and/or functionality) of the system 400 may be similar to that of the systems 100, 200 and/or 300; however, in the system 400, the payment fencing and reward device 106 may receive travel modification information after receiving the additional trip payment fencing information or after receiving the travel purchase information specifying an itinerary for the entity. Travel modification information may be new travel details or information about cancelation, delay, change or other modification to the partial trip payment fencing information received at or accessed by the payment fencing and reward device 106. For example, the entity device 102 may transmit the additional trip payment fencing information indicating that during a trip to South Africa, the entity will travel to Sun City, Pilanesberg National Park for a safari tour on day two of the trip. However, during the trip, the entity may decide to cancel the safari trip and instead attend an excursion to Table Mountain in Cape Town, South Africa. The entity device 102 may transmit travel modification information indicating the new location and times of the trip to Table Mountain and/or update a payment fencing record to remove information about the safari in Sun City.

The payment fencing and reward device 106 may determine a reward for the travel modification information received for the party from whom the travel modification information was received. Shown in FIG. 4 is an embodiment in which the travel partner device 104 provides the travel modification information. In other embodiments, the entity device 102 or any other third-party device may provide the travel modification information and/or receive the reward if the payment fencing and reward device 106 determines that the entity should receive the reward. In this embodiment, for example, the payment fencing and reward device 106 may determine an amount or type of the reward based on how quickly the travel modification information is received by the payment fencing and reward device 106 after the modification occurred.

Since travel often may have unavoidable and unplanned changes, the system 400 may be designed to adapt to such events. As another example, in some embodiments, the payment fencing and reward device 106 may note flight numbers and/or employ an application programming interface (API) to access flight tracking information (e.g., Flightaware) to note the actual take off and/or landing time of air travel for an entity to identify flight delays or cancelations. The actual take off and/or landing time may be travel modification information if such information differs from the original information provided for travel by the entity. The payment fencing and reward device 106 may generate new payment fencing information based on the travel modification information.

The new payment fencing information may allow the authorization processing device 110 to perform payment fencing fraud checks to permit the extended use of payments at a layover location if the next flight is delayed or canceled, for example, without requiring any input from the entity to update the payment fencing and reward device 106 regarding the delay or cancelation. In another example, a diverted flight on which an entity is traveling may land in an unexpected city and, if the fraud system has the flight number and accesses Flightaware data, attempted transactions may be enabled for the new, unexpected location. In some embodiments, concierge services may be alerted so that upon an unexpected diversion to an unknown city, the entity may receive a call from the payment fencing company (e.g., credit card company or bank) offering to set up a hotel or make other various arrangements.

Although not shown, in some embodiments, entity-specific travel services (e.g., Tripit) may connect with airlines to generate a travel itinerary for an entity. The entity-specific travel service may accept entity authorization to allow the entity-specific travel service to provide third-party access to the data. As such, the payment processing device or other third-party may receive entity authorization to access the travel itinerary on behalf of the entity and/or provide the itinerary for the entity to the payment fencing and reward device 106. The payment fencing and reward device 106 may populate a defined payment fencing record with the partial trip payment fencing information based on this information. The payment processing device or other third-party may then receive information indicative of the reward from the payment fencing and reward device 106.

In some embodiments, the third-party that may be provided access to the entity itinerary may be the payment fencing and reward device 106 and/or the authorization processing device 110. In this embodiment, the payment fencing and reward device 106 may provide reward incentives to the entity for adding the payment fencing and reward device 106 and/or the authorization processing device 110 to the notification list for itinerary/trip updates, for example.

FIGS. 1, 2, 3 and/or 4 illustrate mere example sets of operations and/or descriptions for performing one or more functions described herein for the systems 100, 200, 300 and/or 400. In other embodiments, the illustrated operations may be performed in any logical order, omitted, performed concurrently, or the like. All such embodiments are envisaged.

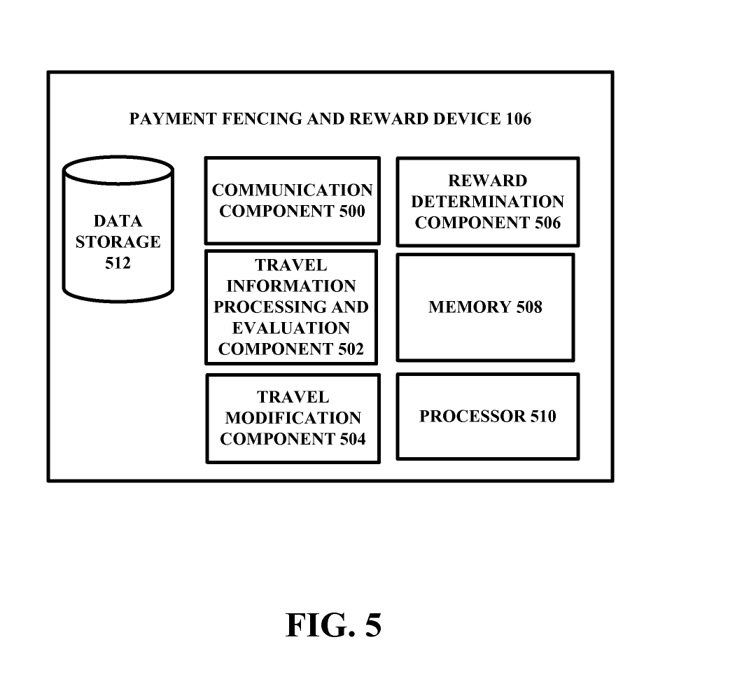

FIG. 5 illustrates an example block diagram of the payment fencing and reward device 106 of the systems of FIGS. 1, 2, 3 and/or 4, which may facilitate the evaluation of the payment fencing information and determination of the reward or rewards to facilitate the anti-fraud measure or measures, in accordance with one or more embodiments described herein. Repetitive description of like elements employed in respective embodiments of systems and/or apparatus described herein are omitted for sake of brevity.

The payment fencing and reward device 106 may comprise a communication component 500, a travel information processing and evaluation component 502, a travel modification component 504, a reward determination component 506, a memory 508, a processor 510 and/or data storage 512. In various embodiments, one or more of the communication component 500, the travel information processing and evaluation component 502, the travel modification component 504, the reward determination component 506, the memory 508, the processor 510 and/or the data storage 512 may be electrically and/or communicatively coupled to one another to perform one or more functions of the payment fencing and reward device 106.

The communication component 500 may receive the travel purchase information, the partial trip payment fencing information and/or the additional trip payment fencing information. The communication component 500 may transmit a request for the additional trip payment fencing information, reward information, or the like. By way of example, but not limitation, the communication component 500 may receive information indicating that travel has been purchased for an entity having a particular credit card or profile. For example, the credit card or profile may be monitored for fraud detection and/or decision making by a third-party device (e.g., the authorization processing device 110) as to whether to accept or decline a requested transaction by the entity during travel. The communication component 500 may receive one or more portions of travel information that may be considered to be or may be employed in formulating the payment fencing information associated with the travel. The communication component 500 may transmit to an entity device (e.g., the entity device 102 shown in FIG. 1) or to a travel partner device (e.g., the travel partner device 104 shown in FIG. 1) or to a banking institution associated with the entity or the travel partner rewards and/or reward information that may be processed for providing cash back or other rebate or incentive in exchange for the travel information received at the communication component 500.

The travel information processing and evaluation component 502 may be configured to process travel information received about a particular entity. For example, the travel information processing and evaluation component 502 may filter travel details from the travel purchase information to generate the partial trip payment fencing information and/or may process and/or evaluate the level of completeness and/or the quality and/or the precision of the additional trip payment fencing information received and/or generate the payment fencing information for travel by the entity.

The travel modification component 504 may receive and/or process information indicative of modifications to travel information previously received.

The memory 508 may be a computer-readable storage medium or device storing computer-executable instructions and/or information for performing the functions described herein with reference to the payment fencing and reward device 106 (or any component of the payment fencing and reward device 106). For example, the memory 508 may store computer-executable instructions that may be executed by the processor 510 to perform receipt and/or processing of the travel purchase information, determination of the reward information, evaluation of the level of completeness and/or the quality of travel information or any other functions of the payment fencing and reward device 106. The processor 510 may perform one or more of the functions described herein with reference to the payment fencing and reward device 106 (or any component of the payment fencing and reward device 106). The data storage 512 may be configured to store information accessed by, received by and/or processed by the payment fencing and reward device 106 (or any component of the payment fencing and reward device 106) comprising, but not limited to, identifiers of travel partners, entities, reward information, levels of completeness and/or quality, or the like.

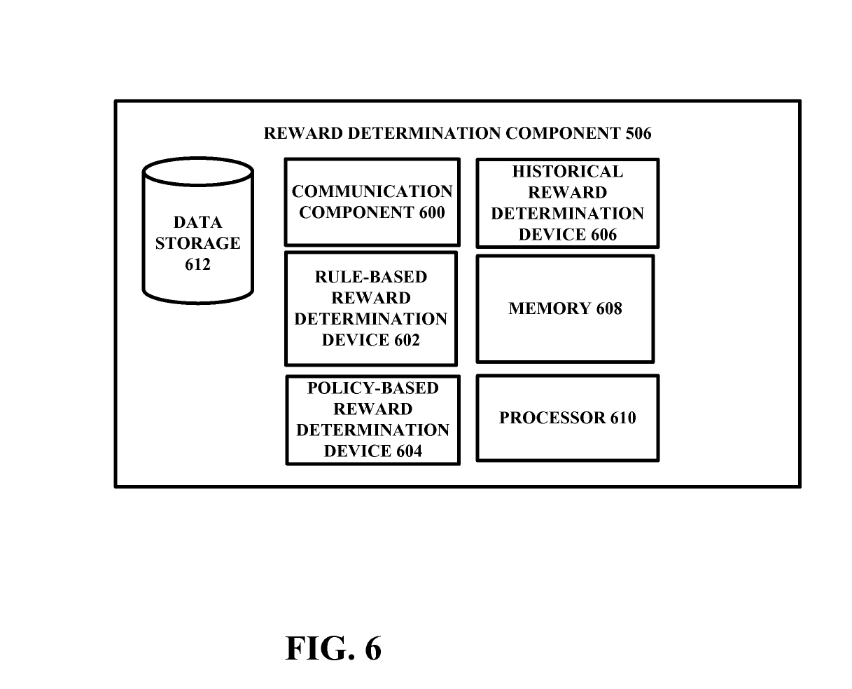

One embodiment of the structure and/or functionality of the reward determination component 506 will be described with reference to FIG. 6. FIG. 6 illustrates an example block diagram of the reward determination component 506 of the payment fencing and reward device 106 of the systems of FIGS. 1, 2, 3 and/or 4, in accordance with one or more embodiments described herein. Repetitive description of like elements employed in respective embodiments of systems and/or apparatus described herein are omitted for sake of brevity.

The reward determination component 506 may comprise a communication component 600, a rule-based reward determination device 602, a policy-based reward determination device 604, a historical reward determination device 606, a memory 608, a processor 610 and/or data storage 612. In various embodiments, one or more of the communication component 600, the rule-based reward determination device 602, the policy-based reward determination device 604, the historical reward determination device 606, the memory 608, the processor 610 and/or the data storage 612 may be electrically and/or communicatively coupled to one another to perform one or more functions of the reward determination component 506.

The communication component 600 may transmit and/or receive information about a travel purchase, the partial trip payment fencing information, the reward information provided to an entity or travel partner for travel information, or the like.

The policy-based reward determination device 604 may select, determine and/or allocate one or more types of rewards and/or one or more amounts of rewards based on the perceived level of difficulty of providing the additional trip payment fencing information. In cases in which the policy-based reward determination device 604 determines that a level of difficulty of providing the additional trip payment fencing information exceeds a defined value, the policy-based reward determination device 604 may generate a signal that causes the reward determination component 506 to select a particular type of reward or a particular amount of an available reward to be provided to the party that provided the additional trip payment fencing information.

The rule-based reward determination device 602 may select, determine and/or allocate one or more types of rewards or one or more amounts of rewards (e.g., percentage of cash back) based on any number of rules. For example, the rule-based reward determination device 602 may provide information indicative of a defined percentage of an available cash back reward if a valid geofence or other location based screening criteria is able to be determined for a defined percentage of travel. The rule-based reward determination device 602 may allocate a particular reward or amount of a reward based on the quality or the precision or the completeness of the additional trip payment fencing information and/or combination of the additional trip payment fencing information and the partial trip payment fencing information.

The historical reward determination device 606 may select, determine and/or allocate one or more types of rewards and/or one or more amounts of rewards based on the reward or amount of reward provided to a particular party in the past in exchange for the additional trip payment fencing information. The historical reward determination device 606 may provide similar rewards over time and/or may provide enhanced rewards relative to previous rewards to attempt to incentivize a party to provide an enhanced amount or number of details as the additional trip payment fencing information relative to previous additional trip payment fencing information provided.

The memory 608 may be a computer-readable storage medium or device storing computer-executable instructions and/or information for performing the functions described herein with reference to the reward determination component 506 (or any component of the reward determination component 506). For example, the memory 608 may store computer-executable instructions that may be executed by the processor 610 to perform receipt and/or processing of the payment fencing information, reward information or any other functions of the reward determination component 506. The processor 610 may perform one or more of the functions described herein with reference to the reward determination component 506 (or any component of the reward determination component 506). The data storage 612 may be configured to store information accessed by, received by and/or processed by the reward determination component 506 (or any component of the reward determination component 506) comprising, but not limited to, the reward information, the level of completeness and/or the quality, or the like.

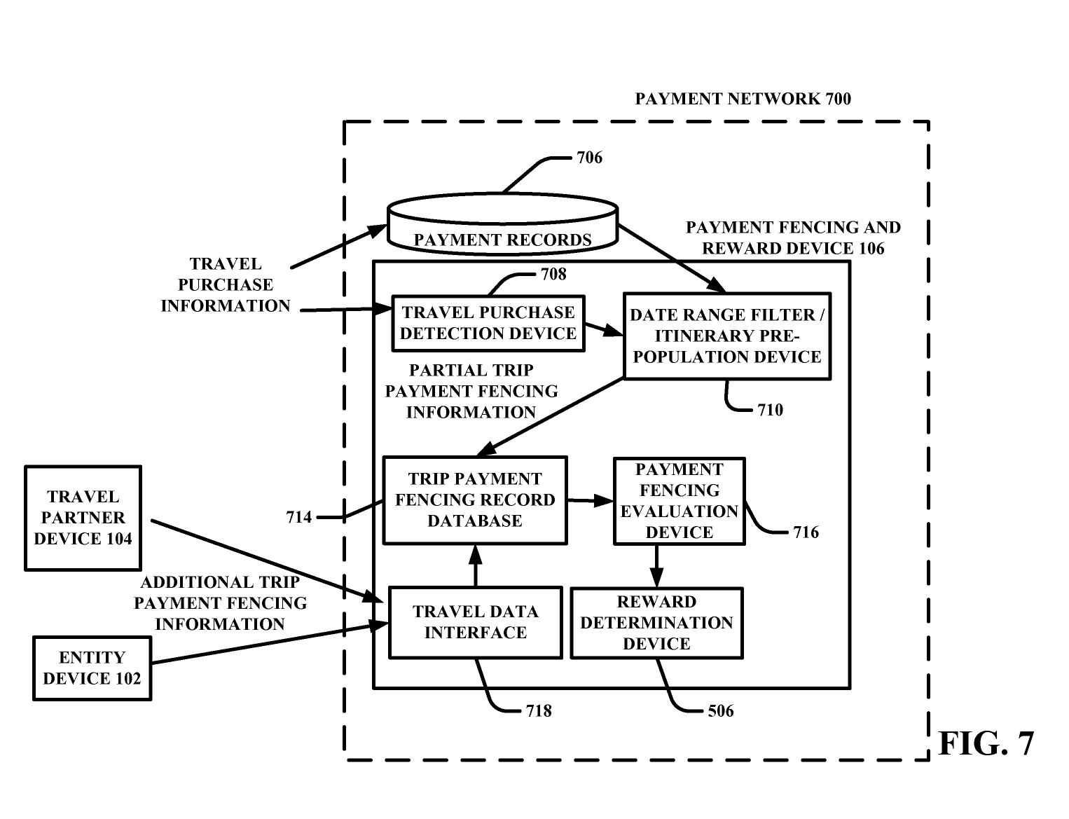

FIG. 7 illustrates an example block diagram illustrating a flow of operations within a payment network 700 employing the example systems of FIGS. 1, 2, 3 and/or 4, which may provide evaluation of the payment fencing information and determination of rewards to facilitate anti-fraud measures, in accordance with one or more embodiments described herein. Repetitive description of like elements employed in respective embodiments of systems and/or apparatus described herein are omitted for sake of brevity.

The payment fencing and reward device 106 may determine travel spending rebates or other rewards for an entity, travel partner or other third-party based on a determined level of completeness of payment fencing received from the entity device 102 associated with the entity, received from the travel partner device 104 associated with a travel partner or received from any number of devices associated with any number of third-parties. As described, the payment fencing and reward device 106 may also provide rewards based on the entity device 102, the travel partner device 104 and/or any other third-party device making information available to the payment fencing and reward device 106 (e.g., providing travel details in a defined payment fencing record, allowing access to travel) (e.g., authorization to access services such as Tripit as discussed above), or the like. As described with reference to FIGS. 1 and 2, in various embodiments, an entity may be a consumer associated with a credit card and for whom travel has been arranged. A travel partner may be a third-party having stored travel purchase information and/or that provides or makes the travel purchase information for an entity accessible to the payment fencing and reward device 106.

In some embodiments, as shown, the stored travel purchase information is received by the payment network 700 and recorded in payment records 706 after verification and/or payment processing for the travel that is the subject of the stored travel purchase information. In the embodiment shown, a travel purchase detection device 708 may detect information about the travel or may detect that travel purchase information has been received. By way of example, but not limitation, the travel purchase detection device 708 may detect the merchant code, transaction identifier or any other type of information about the transaction employed to purchase the travel.

The travel purchase detection device 708 may transmit the transaction identifier or other information received to a date range filter/itinerary pre-population device 710. In some embodiments, the date range filter/itinerary pre-population device 710 may filter and/or process one or more of the payment records 706 and/or cooperating travel partner data to generate the partial trip payment fencing information. The date range filter/itinerary pre-population device 710 may extract and/or determine dates for an itinerary, type of travel (e.g., air travel, cruise ship travel) and/or location (e.g., Chicago, Sydney) of travel identified by the travel purchase information.

The partial trip payment fencing information may comprise, but is not limited to, air, hotel, cruise ship travel arrival and return dates, for example. By way of example, but not limitation, the partial trip payment fencing information may comprise information such as arrival and destination cities, dates and times for flights purchased for an entity. The information may comprise details regarding connection times, dates, cities, whether the flight is a direct flight or a non-stop flight, a name and city of a hotel reserved for an entity, a location for a rental car reserved for an entity, an arrival and/or departure city for a train, bus or cruise ship itinerary, or the like.

The partial trip payment fencing information may be transmitted to, accessed by and/or otherwise stored in a trip payment fencing record database 714. The entity and/or travel partner is incentivized to input the additional trip payment fencing information via a travel data interface 718 to the payment fencing and reward device 106 about specific details of travel by or about entity. For example, the entity device 102 or the travel partner device 104 may receive reward information based on the additional trip payment fencing information provided from the entity device 102 and/or the travel partner device 104.

In some embodiments, the additional trip payment fencing information is transmitted over a wired or wireless channel between the entity device 102, or the travel partner device 104, and the travel data interface 718. The additional travel information may be generated and/or transmitted to the travel data interface 718 in some embodiments. In other embodiments, a human user may manually input the additional trip payment fencing information at the travel data interface 718 (e.g., the travel data interface 718 may be provided at a kiosk within the airport, or the travel data interface 718 may be a webpage to which the traveler is directed after making a travel purchase).

The additional trip payment fencing information provided may be employed for payment fencing and may be stored at the trip payment fencing record database 714. In one embodiment, the partial trip payment fencing information is associated with a particular trip payment fencing record (e.g., trip payment fencing record A) stored at the trip payment fencing record database 714. The additional trip payment fencing information may be stored at trip payment fencing record A or any number of other locations that may be associated with trip payment fencing record A.

In some embodiments, the additional trip payment fencing information may provide additional details that augment one or more of the details provided as part of the partial trip payment fencing information to result in a more complete set of data regarding the details of travel. By way of example, but not limitation, the entity device 102 (or the travel partner device 104) may transmit the additional trip payment fencing information that comprises one or more stops on a cruise ship itinerary, one or more stops on a cruise ship itinerary in which the stops are identified by data or time range for the stop (e.g., Port stop 1: Amalie, St. Thomas, Dec. 21, 2014 from 8 a.m. until 7 p.m. local time; Port stop 2: Frederiksted, St. Croix, Dec. 22, 2014 from 7:30 a.m. until 5 p.m. local time), one or more locations or a path of a guided tour (e.g., Guided Tour from Hong Kong (Jul. 3, 2015) to Shanghai (Jul. 5, 2014) to Bangkok (Jul. 7, 2014)); one or more hotels to be visited during travel (e.g., Mar. 9, 2014 Walt Disney World Resort, Orlando, Fla.; Mar. 10, 2014 Loews Miami Beach Hotel, Miami Beach, Fla.); and/or other such data. In some examples, such data may be entered by a user on the device, may be “cut and pasted” or otherwise electronically obtained from another web page such as a website including information about the travel package, may be provided by a personal electronic scheduling application, etc. The data may be provided in a pre-formatted or rigorous form, or may be provided in an unstructured form, e.g. by natural language processing (NLP), at travel data interface 718 to result in appropriate data that may be utilized by the payment fencing and reward device 106.

In various embodiments, the additional trip payment fencing information may be information comprising a geographical location at which the entity will be located during travel by the entity, and may also comprise time periods during which the entity will be at the geographical locations (e.g., during time period from x to y, entity will be located at z location; during time period from w to q, entity will be located at f location).

In some embodiments, the payment fencing and reward device 106 may augment, add to or modify the partial trip payment fencing information and/or the additional trip payment fencing information based on information received or determined by the payment fencing and reward device 106 as being different from the partial trip payment fencing information. By way of example, but not limitation, the payment fencing and reward device 106 may receive or obtain information indicating that travel plans (or an aspect of travel plans—air travel or hotel stay, for example) has been delayed (e.g., flight delay), canceled or changed (e.g., new flight details; missed train; change in selected cruise ship excursion; change of hotel). The payment fencing and reward device 106 may reward the entity, travel partner or other third-party that provides such information or provides access to such information. The payment fencing and reward device 106 may update the trip payment fencing record database 714 with the information indicating the change in the travel plans. In some other embodiments, the payment fencing and reward device 106 may receive or detect information indicating that the entity traveling has missed a flight or is otherwise not traveling according to the itinerary details previously provided in the partial trip payment fencing information and/or the additional trip payment fencing information and may reward the entity that provides such information and also update the trip payment fencing record database 714.

A payment fencing evaluation device 716 may evaluate a level of completeness, quality and/or precision of the additional trip payment fencing information received and/or of the level of completeness, the quality and/or the precision of a combination of the additional trip payment fencing information and the partial trip payment fencing information by any number of different approaches, calculations or processes. In one embodiment, the payment fencing and reward device 106 may evaluate the level of completeness of the additional trip payment fencing information received by determining a predictable entity travel range and corresponding uncertainty for each day of travel via Hausdorff geometric criteria.

For example, the Hausdorff distance may be computed or otherwise determined as the longest distance from a point in a first set of locations to a point in the other set of locations and thus gives an idea of the amount of distance between locations specified about entity travel. Thus, a smaller Hausdorff distance is typically a more finely grained set of locations that are closer to each other and more specific and will help more with recognizing possible fraud occurrences. While this may be true for locations along a path (such as consecutive locations along a tour route), travel from city to city in a controlled environment (e.g. an airplane) may not introduce fraud possibilities if payments are not expected to be made along intervening locations. As such, the valid potential space for purchasing remains small, and thus a distance metric may also contain computational allowances that judge an air trip or the like as a positive contributor (as opposed to a negative contributor) to certainty. In one example, the Hausdorff metric may be computed across a graph space where a city is represented as a network of location nodes and connection edges that contain distance attributes. In such a graph, airports with transit links between them may be connected by edges of relatively small length when computing a distance metric for a traveler flying between those airports. Such a change may result in a smaller Hausdorff distance for such travel even though the actual span of geographic distance may be large. Other distance metrics, such as Minkowski methods, or other measurements of information content, may also be used.

In some embodiments, the level of quality, precision and/or the level of completeness of the payment fencing may be output to the reward determination component 506. In some embodiments, the level of quality and/or the level of completeness may be determined by the payment fencing evaluation device 716 based on how many of a number of different types of information are provided. By way of example, but not limitation, the level of quality and/or the level of completeness may be a first level if air travel, hotel and tour dates information are received by the payment fencing and reward device 106 whereas the level of quality and/or completeness may be a higher level if the payment fencing and reward device 106 receives air travel, hotel, tour dates, times and path information. In some examples such situations may be evaluated by evaluating the proximity in time and/or location of successive locations in a travel record.

In some embodiments, the level of quality and/or completeness may depend on the nature of the travel and the relative completeness in light of the nature of the travel. For example, if a cruise ship is taken from a port within driving distance of the home of a first entity, the payment fencing and reward device 106 may determine that air travel would not be needed. The payment fencing and reward device 106 may assign the same level of quality and/or completeness to mere receipt of cruise ship itinerary information for the first entity as the level of quality and/or completeness assigned to a second entity that is to fly to the cruise ship port and provides air travel information and the same cruise ship itinerary information provided by the first entity.

In some embodiments, the reward determination component 506 may determine one or more of travel rebates or other rewards for an entity scheduled to travel per the partial trip payment fencing information and/or the additional trip payment fencing information. For example, as an incentive to the entity to cause the entity device 102 to transmit the additional trip payment fencing information to the payment fencing and reward device 106, the reward determination component 506 may determine one or more travel rebates or other rewards for the entity based on receipt of the additional trip payment fencing information.

In some embodiments, the reward determination component 506 may generate information describing or encompassing the reward (e.g., a coupon for dinner for two at a popular restaurant in a city being visited per the itinerary; cash back of a designated amount on a credit card identified in the travel purchase information; cash back on purchases during the travel that benefit from better fraud protection due to the travel data, an electronic check issued to the travel partner or entity traveling). In some embodiments, the reward determination component 506 may transmit instructions and/or information for presentation of the reward (e.g., an automated clearing house (ACH) transfer or other deposit of funds into an account associated with the travel partner or the entity traveling).

In some embodiments, the reward determination component 506 may determine the reward level or type based on a determined difficulty of providing the additional trip payment fencing information. For example, if the additional trip payment fencing information is provided by the entity device 102 while the entity device 102 is outside of the geographical location indicative of a home of the entity, the reward determination component 506 may determine that providing the additional trip payment fencing information from a location when not residing at a home location meets a defined level of difficulty or inconvenience. The reward determination component 506 may therefore provide an enhanced type or level of reward relative to that which would typically be provided by the reward determination component 506 for the additional trip payment fencing information provided from a home location.

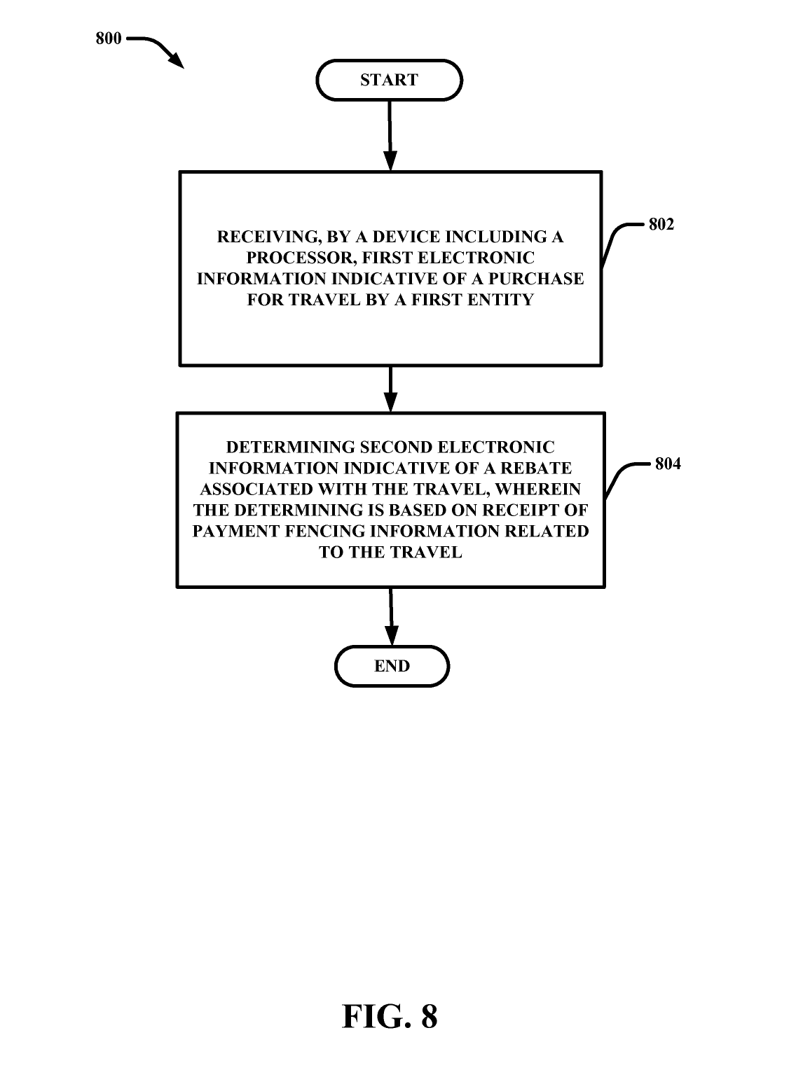

FIGS. 8-12 illustrate flowcharts of example methods 800, 900, 1000, 1100, 1200 associated with evaluation of the payment fencing information and determination of rewards to facilitate anti-fraud measures, in accordance with one or more embodiments described herein. Example methods 800, 900, 1000, 1100, 1200 may, in some embodiments, be performed by one or more systems, devices and/or components such as the systems, devices and/or components described in conjunction with FIG. 1-7 or 13. Turning first to FIG. 8, at block 802, method 800 may comprise receiving, by a device comprising a processor, first electronic information indicative of a purchase for travel by a first entity. Block 802 may be followed by block 804.

At block 804, method 800 may comprise determining second electronic information indicative of a rebate associated with the travel, wherein the determining is based on receipt of payment fencing information related to the travel. In some embodiments, determining the second electronic information indicative of the rebate comprises determining a level of the rebate based on a level of completeness of the payment fencing information.

The payment fencing information may comprise third electronic information indicative of a geographical location at which the first entity will be located during the travel. For example, the third electronic information may comprise information indicative of a first geographical location of travel during a first time period and a second geographical location of travel during a second time period. Accordingly, in some embodiments, although not shown, method 800 may comprise declining (or increasing the likelihood to decline) an electronic request received during the first time period and determined to be from a transaction location greater than a defined distance from the first geographical location.

In some embodiments, although not shown, method 800 may comprise determining the level of completeness of the payment fencing information further based on determining a predictable travel range of the first entity or a corresponding travel uncertainty of the first entity. For example, the determining the predictable travel range or the corresponding travel uncertainty may be based on determining a Hausdorff geometric criterion for the travel.

In some embodiments, although not shown, method 800 may comprise receiving the payment fencing information. For example, in one embodiment, the payment fencing information may be received from a first device associated with the first entity. The method may then comprise associating the rebate with the first entity.

As another example, the payment fencing information may be received from a second device associated with a second entity, wherein the second entity is a third-party that processed the purchase for travel for the first entity. The method may then comprise associating the rebate with the second entity. In some embodiments, the second device is at least one of a travel partner device (e.g., the travel partner device 104) associated with a travel agent, an online travel retailer, or the like.

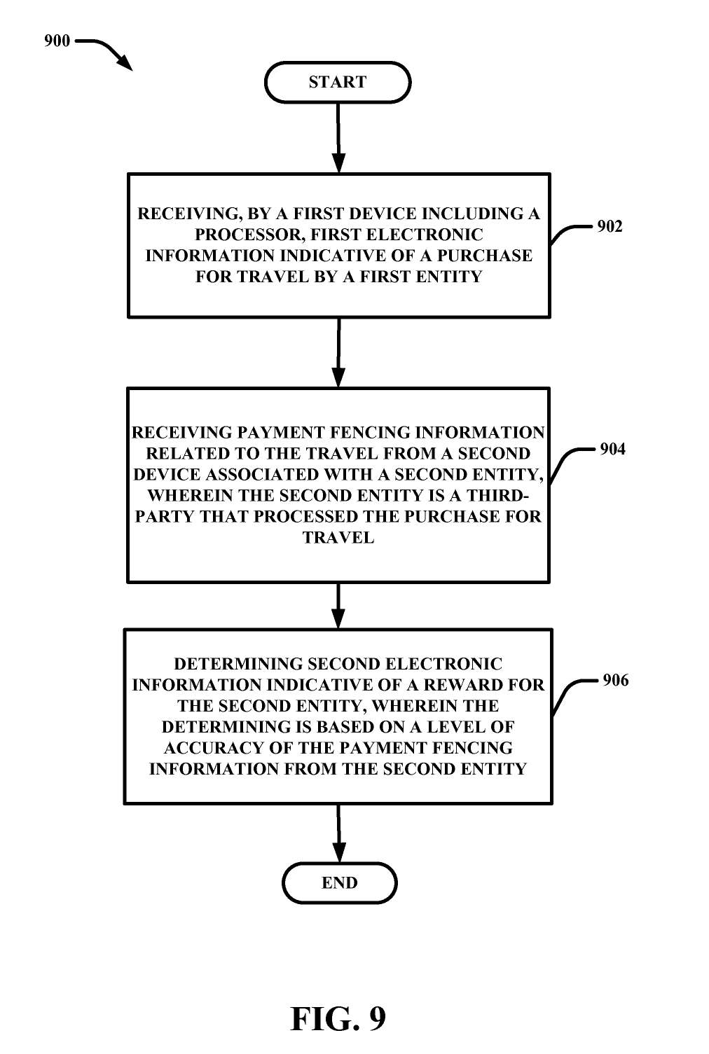

Turning now to FIG. 9, at block 902, method 900 may comprise receiving, by a first device comprising a processor, first electronic information indicative of a purchase for travel by a first entity. Block 902 may be followed by block 904.

At block 904, method 900 may comprise receiving payment fencing information related to the travel from a second device associated with a second entity, wherein the second entity is a third-party that processed the purchase for travel and/or a third-party associated with a website employed for purchasing travel (e.g., ROYAL CARIBBEAN® cruise lines website, TRAVELOCITY® website, VACATION EXPRESS® travel agency website). Block 904 may be followed by block 906.

At block 906, method 900 may comprise determining second electronic information indicative of a reward for the second entity, wherein the determining is based on a level of accuracy of the payment fencing information from the second entity.

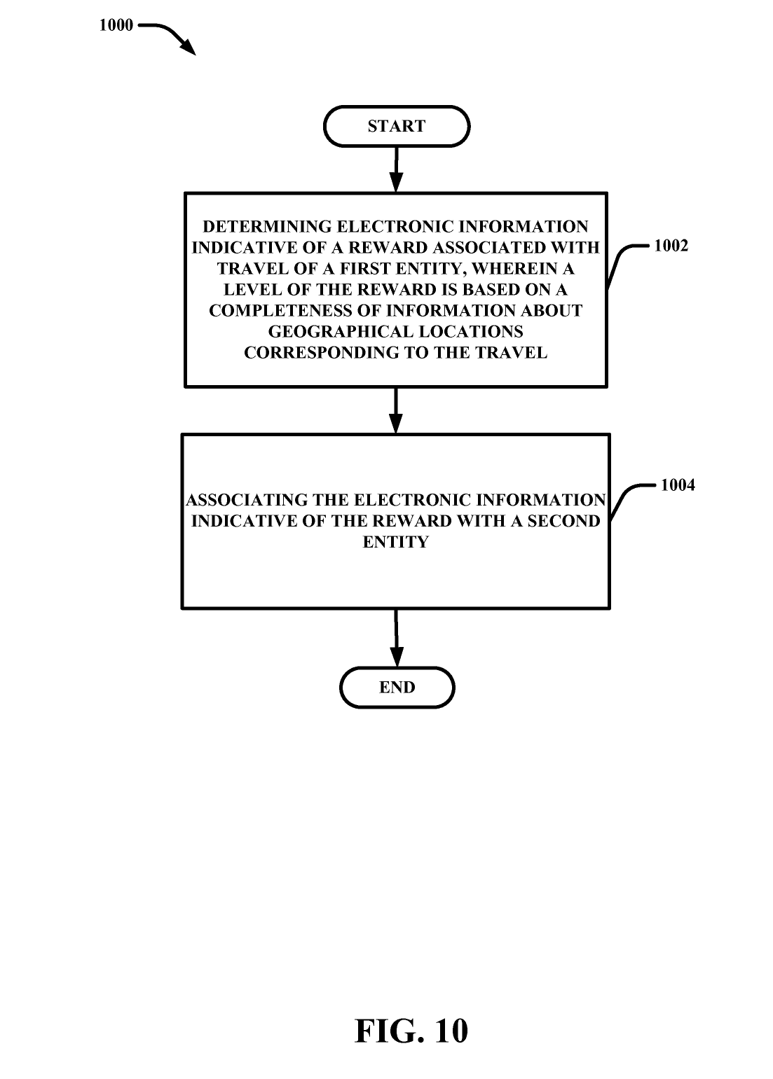

Turning now to FIG. 10, at block 1002, method 1000 may comprise determining electronic information indicative of a reward associated with travel of a first entity, wherein a level of the reward is based on a completeness of information about geographical locations corresponding to the travel. In some embodiments, the first entity is distinct from a second entity, and the second entity is associated with an electronic sale of the travel to the first entity. Block 1002 may be followed by block 1004.

At block 1004, method 1000 may comprise associating the electronic information indicative of the reward with the second entity. In some embodiments, although not shown, method 1000 may comprise determining attempted fraud associated with use of credit card information of the first entity based on determining that a request for a transaction employing the credit card information is being received from a geographical location that is a defined distance from the geographical locations corresponding to the travel.

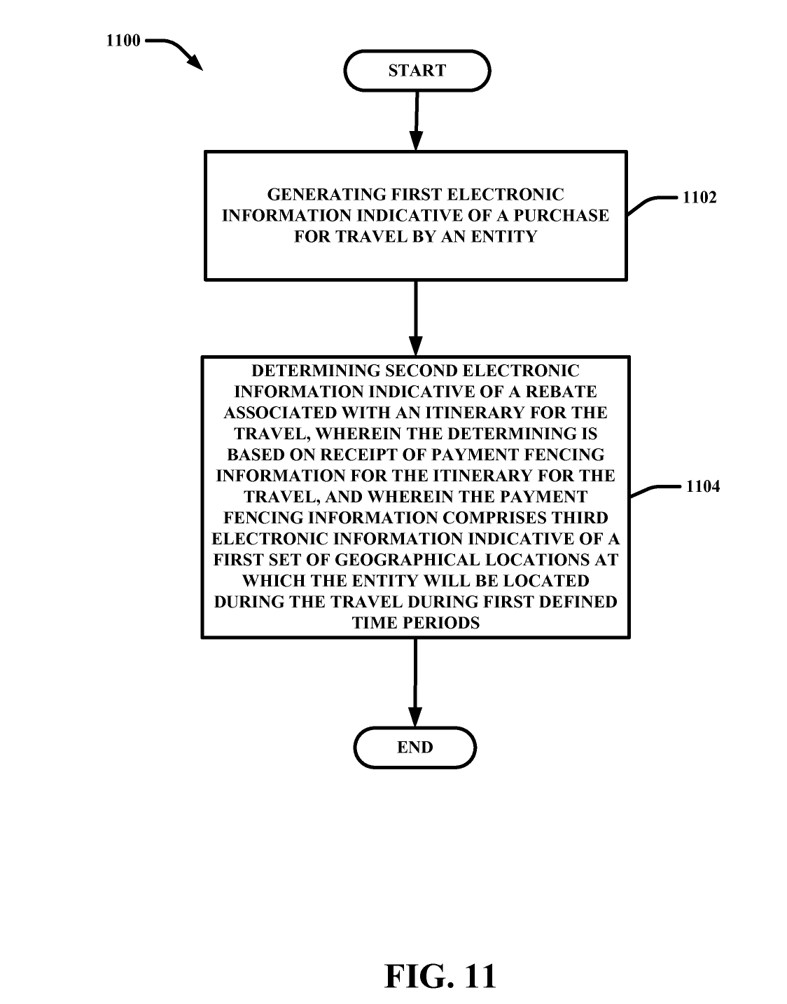

Turning now to FIG. 11, at block 1102, method 1100 may comprise generating first electronic information indicative of a purchase for travel by an entity. In some embodiments, the travel comprises cruise ship travel to a set of countries or a set of regions within a country. Block 1102 may be followed by block 1104.

At block 1104, method 1100 may comprise determining second electronic information indicative of a rebate associated with an itinerary for the travel, wherein the determining is based on receipt of payment fencing information for the itinerary for the travel, and wherein the payment fencing information comprises third electronic information indicative of a first set of geographical locations at which the entity will be located during the travel during first defined time periods.

In some embodiments, the determining second electronic information indicative of the rebate comprises determining a level of the rebate or a type of the rebate based on a level of completeness of the payment fencing information or based on a level of quality of the payment fencing information.

In some embodiments, although not shown, method 1100 may comprise determining fourth electronic information indicative of a second set of geographical locations at which the entity will be located during the travel during second defined time periods based on determining that a travel delay has occurred during the travel to a geographical location of the first set of the geographical locations.

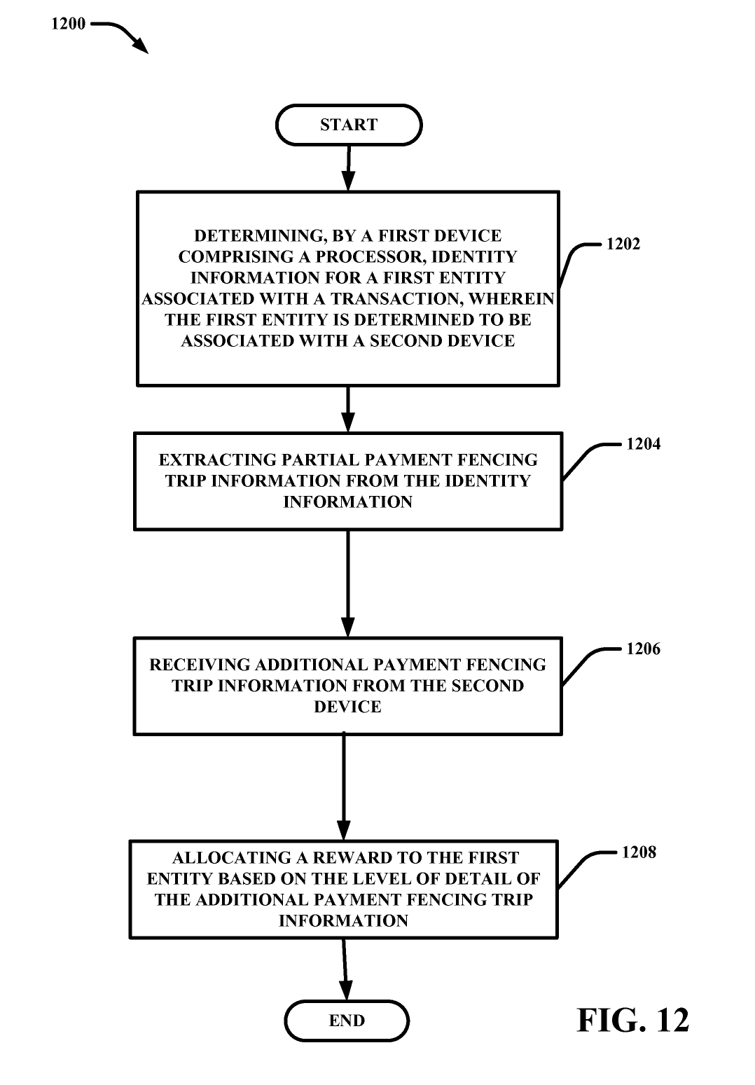

Turning now to FIG. 12, at block 1202, method 1200 may comprise determining, by a first device comprising a processor, identity information for a first entity associated with a transaction, wherein the first entity is determined to be associated with a second device. Block 1202 may be followed by block 1204.

At block 1204, method 1200 may comprise extracting partial payment fencing trip information from the identity information. Block 1204 may be followed by block 1206. At block 1206, method 1200 may comprise receiving additional payment fencing trip information from the second device. Block 1206 may be followed by block 1208. At block 1208, method 1200 may comprise allocating a reward to the first entity based on the level of detail of the additional payment fencing trip information.

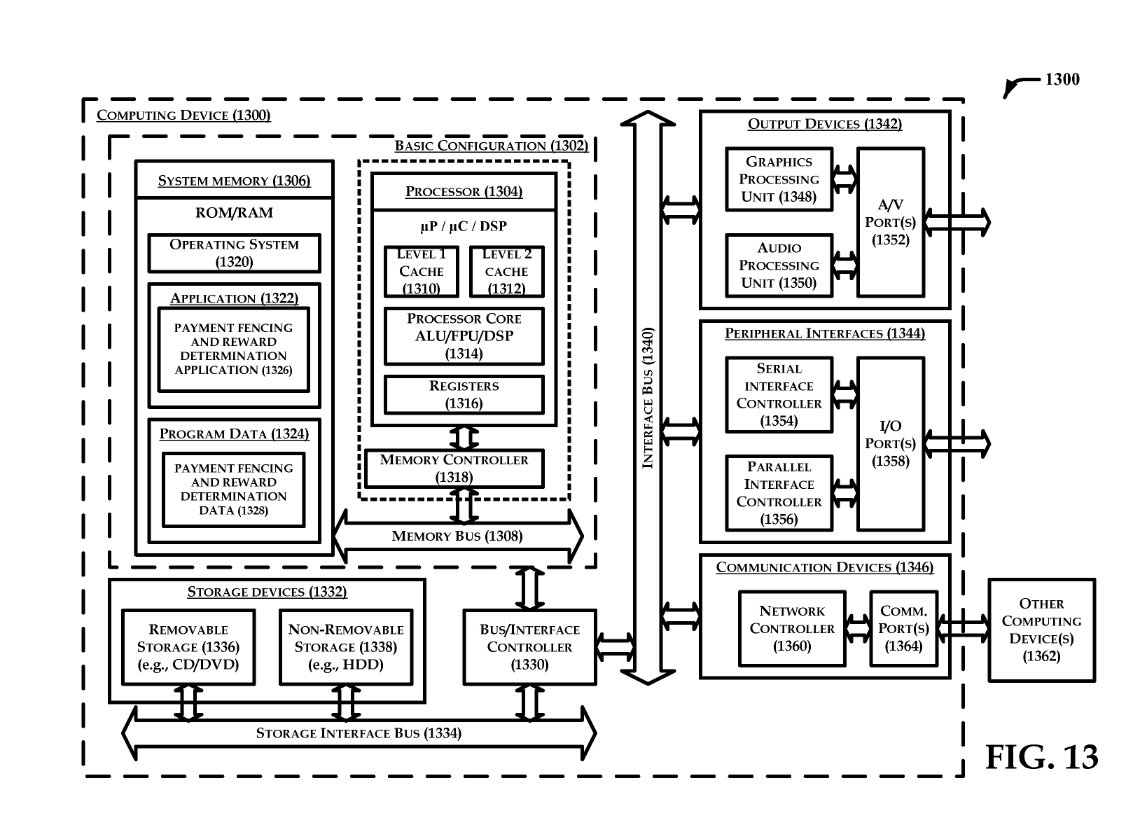

FIG. 13 illustrates an example block diagram of a computing device 1300 that is arranged for evaluation of payment fencing information and determination of rewards to facilitate anti-fraud measures, in accordance with one or more embodiments described herein. In a very basic configuration 1302, computing device 1300 typically comprises one or more processors 1304 and a system memory 1306. In some embodiments, the system memory 1306 may be or comprise the payment fencing and reward device 106, the entity device 102, the travel partner device 104, the banking or credit card institution device 108, the authorization processing device 110 (or any components of the payment fencing and reward device 106, the entity device 102, the travel partner device 104, the banking or credit card institution device 108 or the authorization processing device 110). A memory bus 1308 may be used for communicating between a processor 1304 and the system memory 1306.

Depending on the desired configuration, the processor 1304 may be of any type comprising but not limited to a microprocessor (μP), a microcontroller (μC), a digital signal processor (DSP), or any combination thereof. The processor 1304 may comprise one more levels of caching, such as a level one cache 1310 and a level two cache 1312, a processor core 1314, and registers 1316. An example processor core 1314 may comprise an arithmetic logic unit (ALU), a floating point unit (FPU), a DSP core, or any combination thereof. An example memory controller 1318 may also be used with the processor 1304, or in some implementations, the memory controller 1318 may be an internal part of the processor 1304.

Depending on the desired configuration, the system memory 1306 may be of any type comprising but not limited to volatile memory (such as RAM), non-volatile memory (such as ROM, flash memory, etc.) or any combination thereof. The system memory 1306 may comprise an operating system 1320, one or more applications 1322 (e.g., a payment fencing and reward determination application 1326), and program data 1324 (e.g., a payment fencing and reward determination data 1328). In some embodiments, one or more of the applications 1322 may be arranged to operate with the program data 1324 on the operating system 1320 such that the evaluation of payment fencing information and determination of rewards may be performed as described herein. This described basic configuration 1302 is illustrated in FIG. 13 by those components within the inner dashed line.

The computing device 1300 may have additional features or functionality, and additional interfaces to facilitate communications between the basic configuration 1302 and any devices and interfaces. For example, a bus/interface controller 1330 may be used to facilitate communications between the basic configuration 1302 and one or more data storage devices 1332 via a storage interface bus 1334.

Examples of removable storage and non-removable storage devices comprise magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may comprise volatile and nonvolatile, removable and non-removable media implemented in any method or technology for storage of information, such as computer readable instructions, data structures, program modules, or other data.

The system memory 1306, removable storage devices 1336 and non-removable storage devices 1338 are examples of computer storage media. Computer storage media comprises, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store the desired information and which may be accessed by the computing device 1300. Any such computer storage media may be part of the computing device 1300.

The computing device 1300 may also comprise an interface bus 1340 for facilitating communication from various interface devices (e.g., output devices 1342, peripheral interfaces 1344, and communication devices 1346) to the basic configuration 1302 via the bus/interface controller 1330.

Examples of the output devices 1342 comprise a graphics processing unit 1348 and an audio processing unit 1350, which may be configured to communicate to various external devices such as a display or speakers via one or more A/V ports 1352. Examples of the peripheral interfaces 1344 comprise a serial interface controller 1354 or a parallel interface controller 1356, which may be configured to communicate with external devices such as input devices (e.g., keyboard, mouse, pen, voice input device, touch input device, etc.) or other peripheral devices (e.g., printer, scanner, etc.) via one or more I/O ports 1358. An example of the communication device 1346 comprises a network controller 1360, which may be arranged to facilitate communications with one or more other computing devices 1362 over a network communication link via one or more communication ports 1364.

A network communication link may be one example of a communication media. Communication media may typically be embodied by computer readable instructions, data structures, program modules, or other data in a modulated data signal, such as a carrier wave or other transport mechanism, and may comprise any information delivery media. A “modulated data signal” may be a signal that has one or more of its characteristics set or changed in such a manner as to encode information in the signal. By way of example, and not limitation, communication media may comprise wired media such as a wired network or direct-wired connection, and wireless media such as acoustic, radio frequency (RF), microwave, infrared (IR) and other wireless media. The term computer readable media as used herein may comprise both storage media and communication media.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

The use of hardware or software may be generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples can be implemented, individually and/or collectively, by a wide range of hardware, software, firmware, or virtually any combination thereof. In one embodiment, several portions of the subject matter described herein can be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be possible in light of this disclosure. In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium comprise, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. A typical data processing system may generally comprise one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems comprising feedback loops and control motors. A typical data processing system can be implemented utilizing any suitable commercially available components, such as those typically found in data computing/communication and/or network computing/communication systems.

The herein described subject matter sometimes illustrates different components contained within, or connected with, different other components. Such depicted architectures are merely examples, and many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably coupleable,” to each other to achieve the desired functionality. Specific examples of operably coupleable comprise but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations can be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims can contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

The present disclosure is not to be limited in terms of the particular embodiments described in this application, which are intended as illustrations of various aspects. Many modifications and variations can be made without departing from its spirit and scope. Functionally equivalent methods and devices within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. This disclosure is not limited to particular methods, computer-readable storage devices, systems or apparatus disclosed, which can, of course, vary. The terminology used herein is for the purpose of describing particular embodiments only, and is not intended to be limiting.

What is claimed is:

1. A method, comprising:
receiving, by a device comprising a processor, first electronic information indicative of a purchase for travel by a first entity; and
determining second electronic information indicative of a rebate associated with the travel, wherein the determining is based on receipt of payment fencing information related to the travel.

2. The method of claim 1, wherein the payment fencing information comprises third electronic information indicative of a geographical location at which the first entity will be located during the travel.

3. The method of claim 2, wherein the payment fencing information further comprises fourth electronic information indicative of a time period during which the first entity will be located at the geographical location.

4. The method of claim 3, further comprising:
declining an electronic request received during the time period determined to be from a transaction location greater than a defined distance from the geographical location.

5. The method of claim 1, further comprising:
receiving the payment fencing information.

6. The method of claim 5, wherein the receiving the payment fencing information comprises receiving the payment fencing information from a first device associated with the first entity, and the method further comprises:
associating the rebate with the first entity.

7. The method of claim 5, wherein the receiving the payment fencing information comprises receiving the payment fencing information from a second device associated with a second entity, wherein the second entity is a third-party that processed the purchase for travel, and wherein the method further comprises:
associating the rebate with the second entity.

8. The method of claim 7, wherein the second device is a travel partner device associated with a travel partner.

9. The method of claim 1, wherein the determining the second electronic information indicative of the rebate comprises determining a level of the rebate based on a level of completeness of the payment fencing information determined based on the payment fencing information.

10. The method of claim 1, wherein the determining the second electronic information indicative of the rebate comprises determining a level of the rebate based on a level of completeness of the payment fencing information.

11. The method of claim 10, further comprising:
determining the level of completeness of the payment fencing information further based on determining a predictable travel range of the first entity or a corresponding travel uncertainty of the first entity.

12. The method of 11, wherein the determining the predictable travel range or the corresponding travel uncertainty of the first entity is based on determining a Hausdorff geometric criterion for travel.

13. The method of claim 1, wherein the determining the second electronic information indicative of the rebate comprises determining a level of the rebate based on a level of quality of the payment fencing information determined based on the payment fencing information.

14. A computer readable storage device storing executable instructions that, in response to execution, cause a device comprising a processor to perform operations, comprising:
determining electronic information indicative of a reward associated with travel of a first entity, wherein a level of the reward is based on a completeness of information about geographical locations corresponding to the travel; and
associating, with a second entity, the electronic information indicative of the reward.

15. The computer readable storage device of claim 14, wherein the first entity is distinct from the second entity, and wherein the second entity is associated with an electronic sale of the travel to the first entity.

16. The computer readable storage device of claim 14, wherein the operations further comprise:
determining attempted fraud associated with use of credit card information of the first entity based on determining that a request for a transaction employing the credit card information is being received from a geographical location that is a defined distance from the geographical locations.

17. An apparatus, comprising:
a processor; and
a memory that stores executable instructions that, when executed by the processor, facilitate performance of operations, comprising:
generating first electronic information indicative of a purchase for travel by an entity; and
determining second electronic information indicative of a rebate associated with an itinerary for the travel, wherein the determining is based on receipt of payment fencing information for the itinerary for the travel, and wherein the payment fencing information comprises third electronic information indicative of a first set of geographical locations at which the entity will be located during the travel during first defined time periods.

18. The apparatus of claim 17, wherein the determining second electronic information indicative of the rebate comprises determining a level of the rebate based on a level of completeness of the payment fencing information or based on a level of quality of the payment fencing information.

19. The apparatus of claim 17, wherein the operations further comprise:
determining fourth electronic information indicative of a second set of geographical locations at which the entity will be located during the travel during second defined time periods based on determining that a travel delay has occurred during the travel to a geographical location of the first set of geographical locations.

20. The apparatus of claim 19, wherein the travel comprises a cruise ship travel and the first set of geographical locations comprises a set of countries or a set of regions within a country.
